(19) United States
(12) Patent Application Publication
(10) Pub. No.: US 2003/0140006 A1
(43) Pub. Date: Jul. 24, 2003

(54) Stock bank system and stock bank method

(75) Inventors: Masau Otsuka, Hiroshima (JP); Shigehiko Takayama, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/156,022

(22) Filed: May 29, 2002

(30) Foreign Application Priority Data
Jan. 21, 2002 (JP) 2002-012139

(51) Int. Cl. G06F 17/60; G06F 9/46

(52) U.S. Cl. 705/40; 705/35; 709/318

(57) ABSTRACT

The stock bank system includes a unit which transfers a fund from a user's account to the account in the stock bank, with regard to a preliminary payment on account for a debt, and holds the fund as the preliminary payment on account for the debt, when there is an instruction from the user of the preliminary payment on account for the debt from the user's account. Moreover, there is provided a unit which notifies a business friend of the completion of the preliminary payment on account for the debt, when the transfer is carried out, and deducts the amount of preliminary payment when an acknowledgement of the preliminary payment is obtained from the business friend, or on the due date.

### FIELD OF THE INVENTION

The present invention relates to a stock bank system and a stock bank method for performing debit from an account of a user.

### BACKGROUND OF THE INVENTION

Conventionally, debit from account for installment such as credit is performed in such a manner that the relevant amount is automatically debited from the account on the due date determined at the time of credit agreement, such as “closing in the midst of the month, or closing at the end of the month”.

However, this method has a problem in that, for example, when there is an unexpected income such as casual revenue, and if it is desired to pay the installment payment in advance to reduce the debt, according to a personal intention, such as “since I have enough money this month, I would like to pay in advance for the next month installment (for the month after next)”, but it can be done only by bringing money to the window clerk of the bank (i.e. the clerk at the bank counter).

Other than bringing money to the bank counter, a user has to go to the credit company directly, and it takes time.

### SUMMARY OF THE INVENTION

It is an object of the present invention to make it possible to apply payment on account to the debit by previous arrangement (assignment), or to notify a client (“business friend”) (credit company) of the preliminary credit information so that temporary payment can be done from the bank account, without waiting for the due date of the installment payment (debt).

The stock bank system according to one aspect of the present invention comprises a transfer unit which transfers a fund from a user's account to the account in a stock bank, with regard to a preliminary payment on account for a debt, and holds the fund as the preliminary payment on account for the debt, when there is an instruction from the user of the preliminary payment on account for the debt from the user's account, and a notification unit which notifies a business friend of the completion of the preliminary payment on account for the debt, when the transfer is carried out, and deducts the amount of preliminary payment when an acknowledgement of the preliminary payment is obtained from the business friend, or on the due date.

The stock bank method according to another aspect of the present invention comprises transferring a fund from a user's account to the account in the stock bank, with regard to a preliminary payment on account for a debt, and holding the fund as the preliminary payment on account for the debt, when there is an instruction from the user of the preliminary payment on account for the debt from the user's account, and notifying a business friend of the completion of the preliminary payment on account for the debt, when the transfer is carried out, and deducting the amount of preliminary payment when an acknowledgement of the preliminary payment is obtained from the business friend, or on the due date.

The stock bank method according to still another aspect of the present invention comprises notifying a user when a bill is received from a business friend and receiving an instruction of transfer, transferring the amount of the bill or a partial amount of the bill from the user's account to the account in the stock bank, and holding the fund as a preliminary payment on account, when a transfer instruction is received or when it is set such that notification to the user is not necessary, and notifying the business friend of completion of the preliminary payment on account, when the fund for the preliminary payment is transferred, and deducting the amount of preliminary payment when an acknowledgement of the preliminary payment is obtained from the business friend, or on the due date.

The stock bank method according to still another aspect of the present invention comprises transferring the instructed payment on account under the free title from the user's account to the account in the stock bank, and holding the fund under the free title, when there is an instruction of payment from a user's account under a free title, which does not specify the debit account, from a user, and reserving the fund under the free title for an amount billed, when a bill is received from a business friend, and holding the fund as a preliminary payment on account, as well as notifying the business friend of completion of the preliminary payment on account, and deducting the amount when an acknowledgement of the preliminary payment is obtained from the business friend, or on the due date.

Other objects and features of this invention will become apparent from the following description with reference to the accompanying drawings.

### BRIEF DESCRIPTION OF THE DRAWINGS

FIG. 1 shows a system configuration of the present invention,

FIG. 2 is a flowchart which shows the operation of the present invention (whole operation),

FIG. 3 is a flowchart which shows the operation of the present invention (transaction trigger),

FIG. 4 is a flowchart which shows the operation of the present invention (preliminary payment on account 1),

FIG. 5 is a flowchart which shows the operation of the present invention (preliminary payment on account 2),

FIG. 6 is a flowchart which shows the operation of the present invention (preliminary payment on account 3),

FIG. 7 is a flowchart which shows the operation of the present invention (preliminary payment on account 4),

FIG. 8 is a flowchart which shows the operation of the present invention (billing),

FIG. 9A and FIG. 9B are flowcharts which show the operation of the present invention (reference of information registration/transaction information),

FIG. 10A to FIG. 10D show examples of DB (1) of the present invention, and

FIG. 11A and FIG. 11B show examples of DB (2) of the present invention.

### DETAILED DESCRIPTIONS

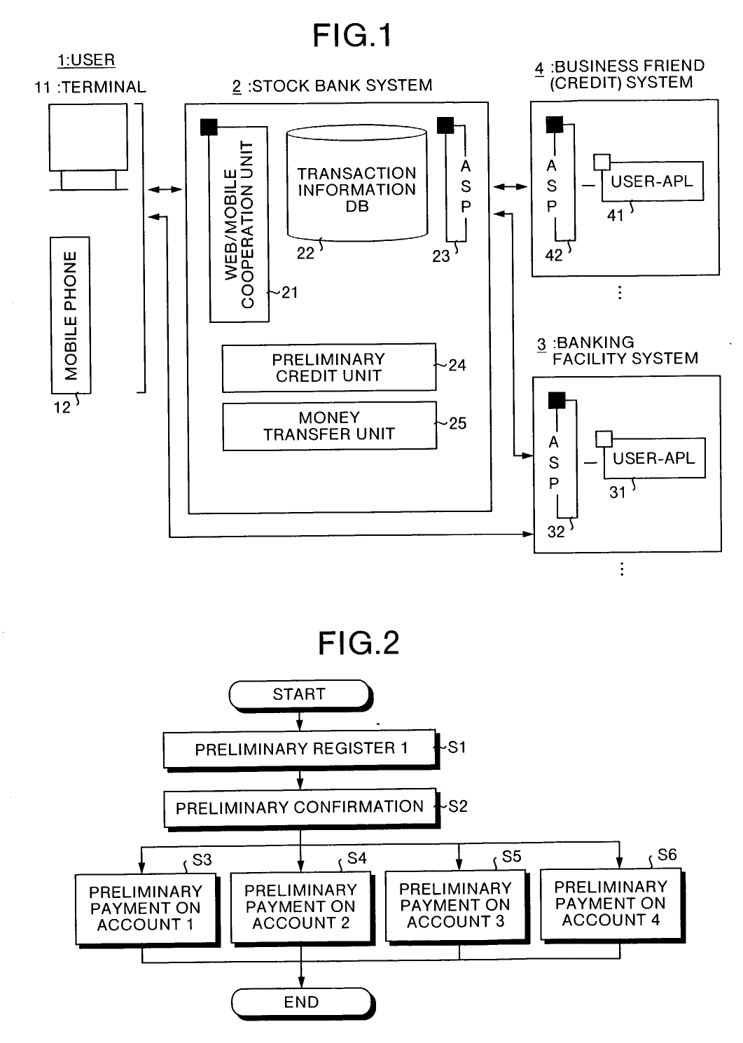

The embodiment and the operation of the present invention will now be explained sequentially, with reference to FIG. 1 to FIG. 11.

FIG. 1 shows the system configuration of the present invention.

In FIG. 1, a user 1 is a terminal of the user, for example, a member terminal 11 or a mobile phone 12.

The member terminal 11 is for instructing debit from the bank account or for requesting a fund transfer from the user's bank account in a banking facility system 3 to a stock bank system 2, by the operation of the user. Various instructions are made on the screen, using a WEB (homepage).

The mobile phone 12 is for receiving (by phone or e-mail) an inquiry when there is a bill from a business friend system 4, or for replying that the preliminary debit for the bill is OK.

The stock bank system 2 is located between the user 1 and the business friend system 4 and the banking facility system 3, for performing various intermediary processing, and comprises a WEB/mobile cooperation unit 21, transaction information DB 22, ASP 23, a preliminary credit unit 24, and a money transfer unit 25.

The WEB/mobile cooperation unit 21 is for receiving credit instructions and making an inquiry if a money transfer is to be performed with respect to a bill to the motile phone 12, through a WEB (homepage) between the stock bank system 2 and the member terminal of the user 11.

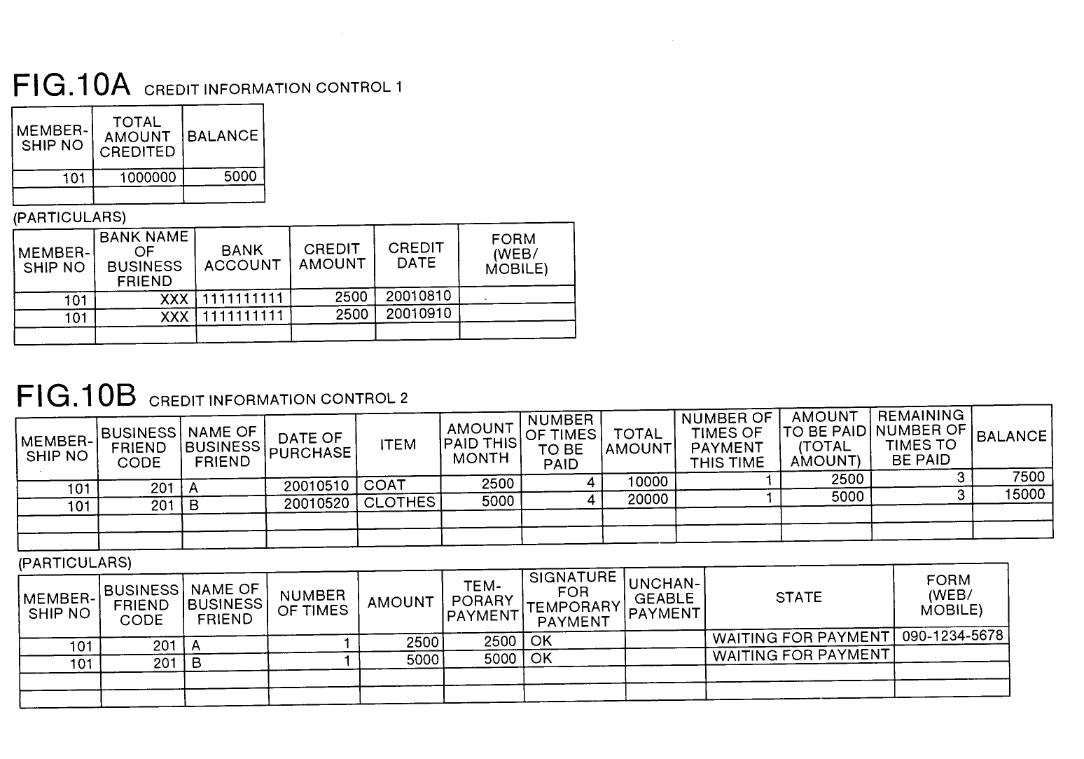

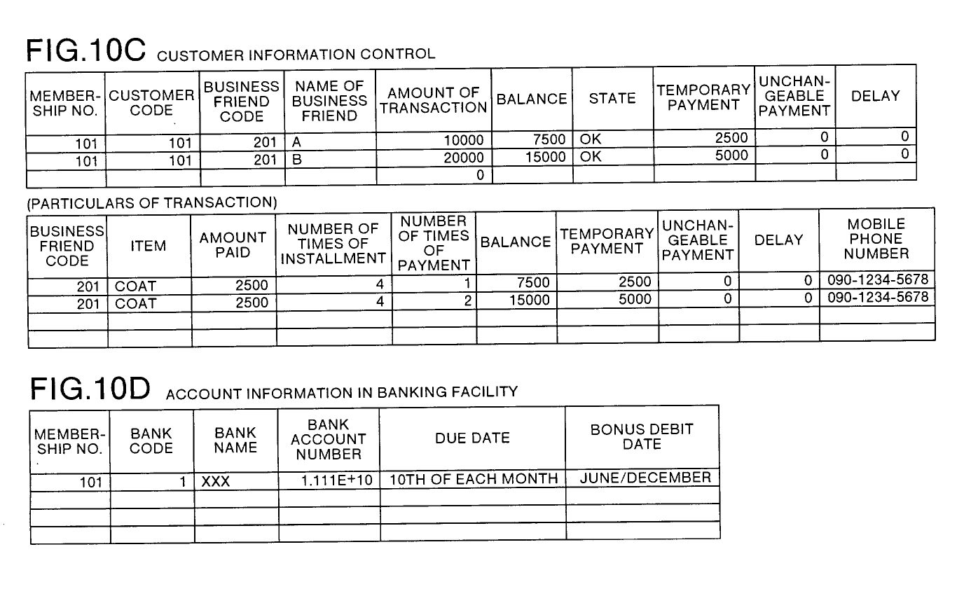

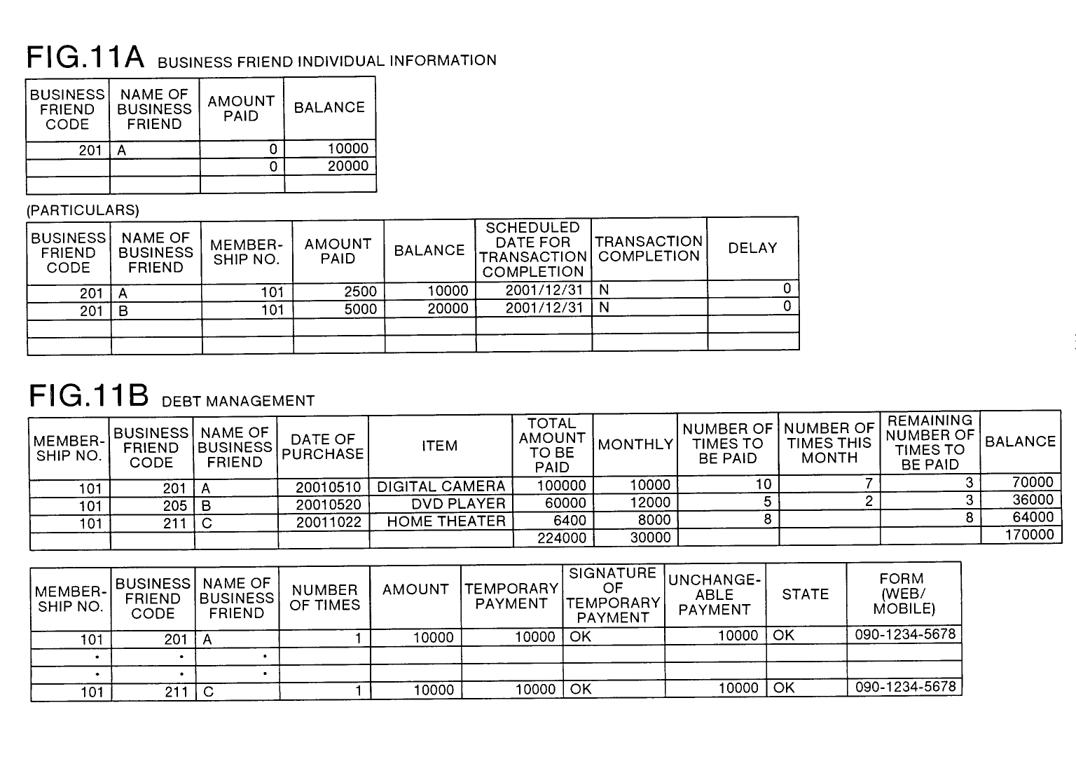

The transaction information DB 22 is DB (database) for registering and setting various information necessary for performing a fund transfer for the user, and is as shown in FIG. 10 and FIG. 11.

The ASP 23 is an interface, which transfers data (data related to the fund transfer of the user) safely, between the banking facility system 3 and the business friend system 4.

The preliminary credit unit 24 is for transferring fund from the user's account in the banking facility system 3 to the account in the stock bank system 2 in advance (which will be explained later with reference to FIG. 2 to FIG. 11).

The money transfer unit 25 is for performing a money transfer (which will be explained later with reference to FIG. 2 to FIG. 11).

The banking facility system 3 is a banking facility in which the user has an account, and comprises herein a USER-APL 31 and an ASP 32.

The USER-APL 31 is a user application for controlling a fund transfer of the user, (which will be explained later with reference to FIG. 2 to FIG. 11).

The ASP 32 is an interface, which transfers data (data related to the fund transfer of the user) safely, between the stock bank system 2 and the banking facility system 3.

The business friend system 4 is a system in a company to which the user makes a fund transfer from his bank account, and for example, a system in a credit company, and comprises a USER-APL 41 and an ASP 42.

The USER-APL 41 is a user application for deducting the price of products which the user has purchased from the bank account of the user on the due date, (which will be explained later with reference to FIG. 2 to FIG. 11).

The ASP 42 is an interface, which transfers data (data related to the fund transfer of the user) safely, between the stock bank system 2 and the business friend system 4.

The operation of the configuration in FIG. 1 will be explained in detail sequentially, with reference to FIG. 2 to FIG. 11.

FIG. 2 is a flowchart which shows the operation of the present invention (whole operation).

In FIG. 2, at step S1, preliminary registration is carried out. That is, member ID (user ID), password, name and account number in the banking facility system 3 used for money transfer are registered in the stock bank system 2 in advance.

At step S2, preliminary confirmation is performed. That is, the member ID, member's name and account number in the banking facility system 3, which are registered at step S1, are confirmed in advance.

In from S3 to S6, processing of from preliminary payment on account 1 to 4 is carried out. That is, processing of from preliminary payment on account 1 to 4 shown in FIG. 4 to FIG. 7 described later is carried out.

As described above, a member (user) preliminarily registers and confirms personal information (member ID, password, account number and name in the banking facility system 3) in the stock bank system 2, thereby processing of preliminary payment on account of from preliminary payment on account 1 to 4 shown in FIG. 4 to FIG. 7 can be performed. This will be explained below in detail sequentially.

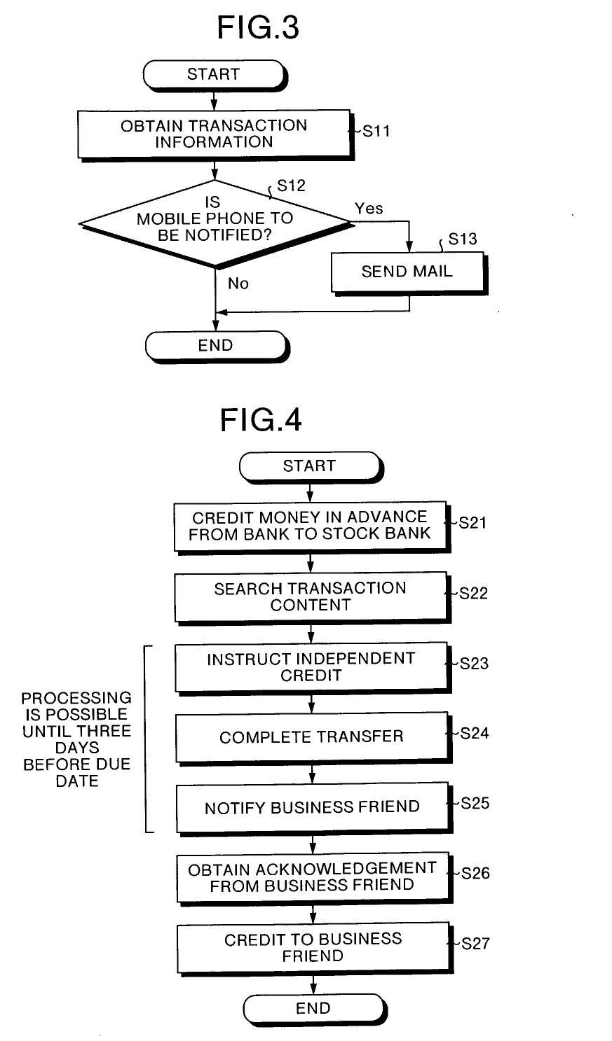

FIG. 3 shows a flowchart which shows the operation of the present invention (operation trigger).

In FIG. 3, at step S11, transaction information is obtained.

At step S12, it is judged whether a mobile phone is to be notified. In the instance of YES, at step S12, mail sending is performed with respect to the registered mobile phone of the user, and control is completed. On the other hand, in the instance of NO, control is completed without performing the step at step S12.

In this manner, when the stock bank system 2 acquires the information, it becomes possible to send an electronic mail to the member, if it is set that there is a mobile phone to be informed, corresponding to the member ID, to confirm if there is any instruction from the member, and to give acknowledgement.

FIG. 4 is a flowchart which shows the operation of the present invention (preliminary payment on account 1).

In FIG. 4, at step S21, fund is transferred in advance from the bank to the stock bank. That is, the member freely transfers fund from his/her own account in the banking facility system 3 to the stock bank system 2 in advance (hereinafter referred to as free credit). Thereby, the amount freely credited by the member (the credit balance) is stored in the stock bank 2.

At step S22, transaction content is searched.

At step S23, independent credit is instructed. That is, the following credit instruction is given.

(1) Instruct to credit for each particulars for each banking facility system 3.

(2) Credit processing is performed by transferring fund from the member's account in the banking facility system 3 to the account in the stock bank system 2.

(3) At this time, as at step S12, a fund transfer from the member's account in the banking facility system 3 to the account in the stock bank system 2 may be carried out together, as a free credit which does not require particulars.

At step S24, transfer is completed. That is, transfer from the banking facility system 3 to the stock bank system 2 is completed according to the credit processing of (2) and free credit processing of (3) at step S23.

At step S25, notification to the business friend is performed. That is, at a point of time when the credit processing has been completed, with the completion of money transfer at step S24, completion of payment on account is notified to the business friend system 4 (the fund is held in the stock bank system 2 until the due date, and transferred to the account in the business friend system 4 on the due date).

At step S26, acknowledgement of the business friend is received. That is, completion of transfer is notified to the business friend system 4 at step S25, and the stock bank system 2 receives an acknowledgement from the business friend system 4.

At step S27, debit for the business friend is performed. This is performed by the following debit processing.

(1) Fund transfer is performed from the stock bank system 2 to the account of the business friend system 4. At this time, the surplus amount or the price of a cancelled product may be returned to the member's account in the banking facility system 3 from the stock bank system 2 on the due date.

(2) When the amount billed is compared with the preliminary payment on account and if there is a deficiency, the stock bank system 2 may debit the deficit to the member's account in the banking facility system 3 on the due date.

As described above, it becomes possible that the member freely deposits a transfer fund from the account in the banking facility system 3 to the stock bank system 2, or transfers money from the account in the banking facility system 3 to the stock bank system 2 based on the particulars, or when the fund is transferred, the stock bank system 2 notifies the business friend system 4 of the completion of fund transfer and holds the money after receiving the acknowledgement, and debits the fund from the account in the stock bank system 2 and transfers the money to the account of the business friend system 4 on the due date. If there is a deficiency, the stock bank system 2 debits and transfers the deficit from the member's account in the banking facility system 3, or when there is surplus or there is an instruction from the member, the stock bank system 2 transfers the money to the member's account in the banking facility system 3.

FIG. 5 is a flowchart which shows the operation of the present invention (preliminary payment on account 2).

In FIG. 5, at step S31, a member instructs free credit. That is, the member instructs a fund transfer to the stock bank system 2 with an optional title, without particulars, from his/her own account in the banking facility system 3.

At step S32, individual payment is instructed. That is, corresponding to the member's instruction of free credit at step S31, the banking facility system 3 transfers the instructed amount of payment from the member's account to the stock bank system 2 under an optional title.

At step S33, the transfer is completed. By the completion of transfer, the stock bank system 2 updates the balance in the member's account with the deposited amount under the member's free intention, and keeps the money.

As described above, the member can transfer and deposit money from his/her account in the banking facility system 3 to the account in the stock bank system 2 at his/her leisure, to update the balance. This balance can be automatically transferred to the account in the business friend system 4 and deducted therefrom on the due date. When there is deficit in the balance, the deficit is deducted from the member's account in the banking facility system 3 and transferred to the business friend system 4, or when there is surplus fund in the balance, the surplus can be returned to the member's account in the banking facility system 3, under instruction from the member.

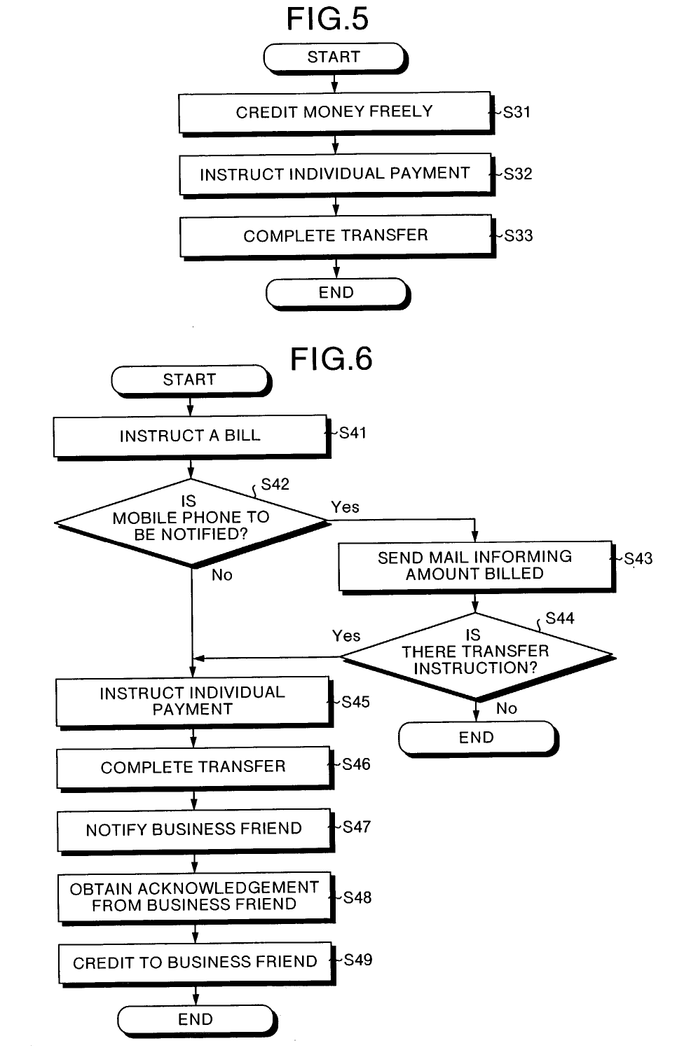

FIG. 6 is a flowchart which shows the operation of the present invention (preliminary payment on account 3).

In FIG. 6, at step S41, a bill is instructed. This is performed in such a manner that the business friend system 4 notifies the stock bank system 2 of the particulars to the member and the amount of billed.

At step S42, it is judged whether there is a mobile phone to be notified. That is, when the stock bank system 2 received the bill instruction at step S41, it is judged whether it is set that a notification to a mobile phone is required, when there is a bill, in the member's information. If it is YES, an electronic mail notifying the amount billed is sent to the mobile phone at step S43, and control proceeds to S44. If NO at step S42, control proceeds to S45.

At step S43, the electronic mail in which the amount billed is set at step S42 is sent to the member, and it is judged whether there is a transfer instruction. If YES, since it is judged that there is a response from the member to instruct a transfer with respect to the bill, control proceeds to S45. If NO at step S43, the processing is terminated.

At step S45, individual payment on account is instructed. That is, corresponding to the bill instruction at step S41, the banking facility system 3 transfers the amount billed (or a part of the amount billed) from the member's account to individually make payment for each title in the bill.

At step S46, the transfer is completed. By the completion of transfer, the stock bank system 2 holds the amount individually credited with respect to the bill.

At step S47, the stock bank system 2 notifies this to the business friend. That is, at a point of time when the transfer has been completed at step S46, the stock bank system 2 notifies the business friend system 4 of the completion of transfer (the stock bank system 2 keeps the fund until the due date, and transfers the amount to the account of the business friend system 4 on the due date).

At step S48, the stock bank system 2 receives an acknowledgement of the business friend. That is, the stock bank system 2 notifies the business friend system 4 of the completion of transfer at the S47, and receives an acknowledgement from the business friend system 4.

At step S49, debit for the business friend is performed. This is performed by the following debit processing.

(1) Fund transfer is performed from the stock bank system 2 to the account of the business friend system 4. At this time, the surplus amount or the price of a cancelled product may be returned to the member's account in the banking facility system 3 from the stock bank system 2 on the due date.

(2) When the amount billed is compared with the preliminary payment on account and if there is a deficiency, the stock bank system 2 may debit the deficit to the member's account in the banking facility system 3 on the due date.

As described above, it becomes possible that if the member notification is set, when there is a bill, it is notified, and when there is a transfer instruction, the amount is transferred from the member's account in the banking facility system 3 to the stock bank system 2, and the stock bank system 2 holds the individual payment fund and transfers the amount from the account in the stock bank system 2 to the account of the business friend system 4 and debits the fund on the due date, or if the member notification is not set, the amount is always transferred from the member's account in the banking facility system 3 to the account in the stock bank system 2 and the stock bank system 2 holds the individual payment fund and transfers the amount from the account in the stock bank system 2 to the account of the business friend system 4 and debits the fund on the due date. If there is a deficiency, the stock bank system 2 debits and transfers the deficit from the member's account in the banking facility system 3, or if there is surplus or there is an instruction from the member, the stock bank system 2 transfers the amount of surplus to the member's account in the banking facility system 3.

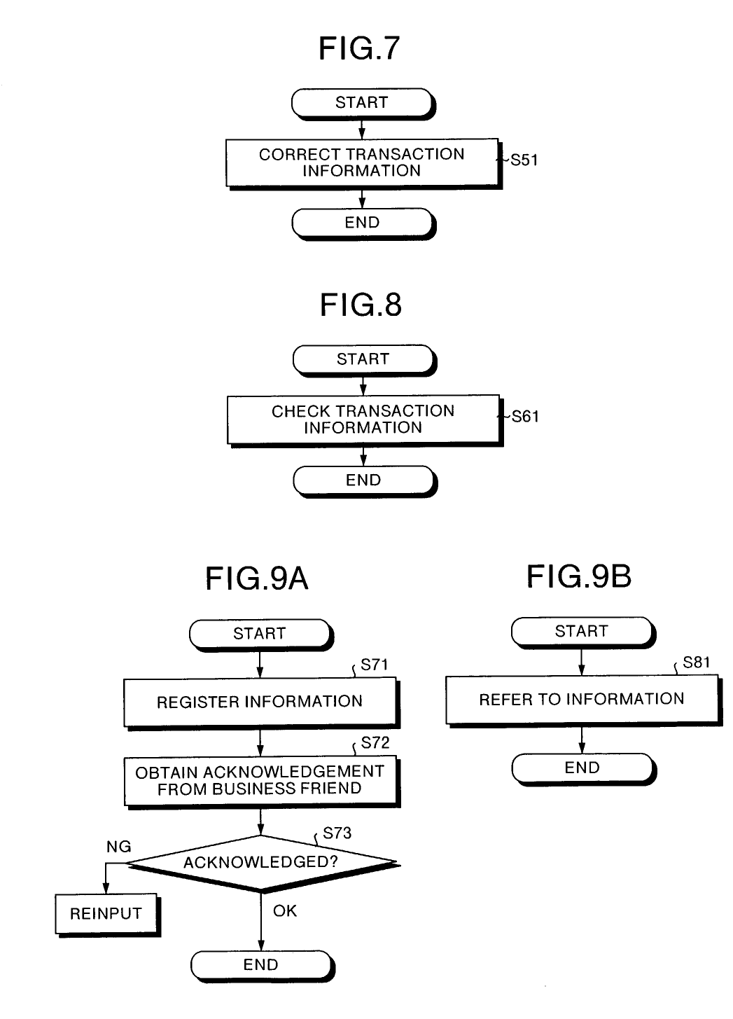

FIG. 7 is a flowchart which shows the operation of the present invention (preliminary payment on account 4).

In FIG. 7, at step S51, the transaction information is corrected. This is performed such that, the member brings, for example, the whole amount to be debited directly to the window clerk of the business friend system 4 to thereby make payment, so as to cancel the debit agreement on the due date (for example, cancel the credit of an A Credit Company).

As described above, the member can directly visit the window clerk of the business friend system 4 by himself/herself to make payment, to correct the transaction information.

FIG. 8 is a flowchart which shows the operation of the present invention (billing).

In FIG. 8, at step S61, the transaction information is checked. That is, the stock bank system 2 receives the particulars information notifying that the debit has been completed, and updates the DB of the stock bank system 2 (see FIG. 10 and FIG. 11 explained later).

FIG. 9A and FIG. 9B are flowcharts which show the operation of the present invention (reference of information registration/transaction information).

As shown in FIG. 9A, at step S71, information is registered. That is, at the time of making an agreement with the stock bank system 2, the following basic information is prepared and registered based on the member information.

Information of business friend: credit company, company having a loan agreement.

Information of debit account: name of bank to be debited, type of account, account name, account number, etc.

Form of payment directly performed from the stock bank to the account of the business friend system 4.

Form of transfer from the stock bank system 2 to the debit account.

Cooperation with mobile phone: notification at the time of using credit (if notification is to be performed to a mobile phone at step S42 in FIG. 6 as described above), reference to information, etc.

Approval or denial of payment in a unit of transaction.

At step S72, it is confirmed if there is an acknowledgement from the business fried. This is performed in such a manner that the stock bank system 2 confirms the member's information with the business friend system 4, to obtain the acknowledgement.

At step S73, it is judged whether the acknowledgement is obtained. That is, it is judged whether the acknowledgement at step S72 has been obtained (“OK”) or not (“NG”). In the instance of OK, control is completed. In the instance of NG, reinput is performed, to repeat control.

In this manner, the stock bank system 2 obtains a preliminary acknowledgement of the business friend system 4 based on the member's information, and can perform various processing related to the member, shown in FIG. 3 to FIG. 8.

In FIG. 9B, at step S81, the information is referred. This is performed in such a manner that the member inputs the membership number and the password, and refers to necessary information of,

basic information,

information of the business friend, and

individual information (payment situation) by business friend.

FIG. 10A to FIG. 11B show examples of DB of the present invention. This is an example of the transaction information DB 22 stored in the stock bank system 2.

FIG. 10A shows an example of DB of credit information control 1.

The upper row in FIG. 10A shows main information of the credit information control 1, wherein the following information is registered corresponding to each other.

membership number

total amount credited

balance

The membership number is a member's ID registered in advance in the stock bank system 2 shown in FIG. 1, and the total amount credited indicates total amount credited so far (for example, total amount for September, or for a predetermined number of months, or for one year), and the balance shows the balance after a debit has been made from the total amount credited.

The particulars in the lower row in FIG. 10A shows the detailed contents of the upper row, wherein the following information is registered corresponding to each other.

membership number

bank name of the business friend

bank account

credit amount

credit date

form (WEB/mobile)

others

The membership number is a member's NO registered in the stock bank system 2, the bank name of the business friend is a name of the bank with which the member having the membership number has business relations (the name of the banking facility system 2 in FIG. 1), the bank account is a name of bank account of the member having the membership number (for example, savings account, account number, account name, etc.), the credit amount indicates the amount credited by a fund transfer from the bank to the stock bank system 2, the credit date shows the date when the credit is made, and the form indicates whether the credit is instructed from the WEB/mobile cooperation unit 21 or a mobile phone.

The information shown in FIG. 10A and FIG. 10B is controlled by the stock bank system 2, thereby it becomes possible to control the total amount credited and the balance for each membership number, and as the particulars thereof, the bank name of the business friend, bank account information, credit amount and credit date, and when there is a balance, it is credited to the account of the business friend system 4, or when the balance is not sufficient, the deficit is debited from the bank account of the member in the banking facility system 3 and transferred to the account of the business friend system 4.

FIG. 10B shows an example of DB of credit information control 2.

The upper row in FIG. 10B shows main information of the credit information control 2, wherein the following information is registered corresponding to each other.

membership number

business friend code

name of business friend

date of purchase

item

amount paid this month

number of times to be paid

total amount

number of times of payment this time

amount to be paid (total amount)

remaining number of times to be paid

balance

others.

The membership number is a member's ID registered in advance in the stock bank system 2 shown in FIG. 1, the business friend code is a code of a company in the business friend system 4, the name of business friend is a company name in the business friend system 4, the date of purchase indicates the date when goods are purchased, item indicates an item of purchased goods, the amount paid this month indicates the amount paid in this month when goods are purchased by installment plan, the number of times to be paid indicates the total number of times to be paid when goods are purchased by installment plan, the total amount indicates the total amount of the purchased goods, the number of times to be paid this time indicates the number of times to be paid in this month, the amount paid (total amount) indicates total amount having been paid up to now, the remaining number of times to be paid indicates the number of times to be paid in the future, and the balance indicates the balance to be paid.

By registering and controlling the information shown in the upper row of FIG. 10A, it becomes possible to collectively control the amount paid in this month, the number of times to be paid, number of times to be paid this time, the amount, the remaining number of times to be paid, and the balance for each member by membership number, and the payment situation can be informed to the member in response to an inquiry.

The particulars in the lower row in FIG. 10(b) shows the detailed contents of the upper row including temporary credit, wherein the following information is registered corresponding to the membership number.

membership number

business friend code

name of business friend

number of times

amount

temporary payment

signature for temporary payment

unchangeable payment

state

form (WEB/mobile)

others.

The membership number, business friend code, name of business friend and form are the same as in the upper row in FIG. 10(b), and hence the explanation thereof is omitted. The number of times indicates the number of times of debit in this month, the amount indicates the amount to be debited in this month. The temporary payment indicates the amount of temporary payment to the stock bank system 2 before the due date, and the signature for temporary payment indicates whether an acknowledgement from the business friend system 4 is OK, and the unchangeable payment indicates whether actual payment (debit) is carried out, and the state indicates the payment waiting state or the like.

By registering and controlling the information shown in the lower row of FIG. 10B, it becomes possible to collectively control the temporary payment, the amount paid, and the like for each member by membership number, and the temporary payment situation can be informed to the member in response to an inquiry.

FIG. 10C shows an example of DB for controlling the customer information.

The upper row in FIG. 10C shows the main information of the customer control information, wherein the following information is registered corresponding to each other.

membership number

customer code

business friend code

name of business friend

amount of transaction

balance

state

temporary payment

unchangeable payment

delay

others.

The membership number is a member's NO (number) registered in the stock bank system 2, the customer code is a customer code corresponding to the membership NO, the business friend code is a code of the business friend system 4, the name of business friend is a company name of the business friend system 4, the transaction amount indicates the transacted amount, the balance indicates the customer's (member's) balance, the unchangeable payment indicates the amount debited on the due date (transferred amount), and delay indicates whether the transfer is delayed.

The particulars in the lower row in FIG. 10(c) shows the detailed information related to the upper row of FIG. 10(c), wherein the following information is registered corresponding to each other.

business friend code

item

amount paid

number of times of installment

number of times of payment

balance

temporary payment

unchangeable payment

delay

mobile phone number

others.

The business friend code is the business friend code in the upper row of FIG. 10C, the item indicates the purchased product name, the amount paid indicates the amount paid in each month, the balance indicates the balance to be paid, the temporary payment indicates an amount of temporary payment, the unchangeable payment is the actually debited amount, delay indicates whether the transfer is delayed. The mobile phone number shows the telephone number to be contacted.

By registering and controlling the information in the upper and lower rows of FIG. 10C, it becomes possible to collectively control the amount paid, number of times of installment, number of times of payment, temporary payment and unchangeable payment by item for each customer (member), and to inform the amount paid or the like by item purchased for each customer (member), in response to an inquiry.

FIG. 10D shows an example of DB of the account information in the banking facility. The following information is registered corresponding to each other.

membership NO

bank code

bank name

bank account number

due date

bonus debit date

others.

The membership NO indicates the membership number registered in the stock bank system 2, the bank code, bank name, bank account number, due date and bonus debit date indicates the bank code, bank name, bank account number, due date and bonus debit date of the bank where the member has a debit account.

By registering the member's account information of the banking facility as shown in FIG. 10D, it becomes possible to freely credit fund from the member's account to the account in the stock bank system 2, to perform individual payment, or to credit money to the member's account.

FIG. 11A shows an example of business friend individual information DB.

The upper row in FIG. 11A shows the main information of the business friend individual information. The following information is registered corresponding to each other.

business friend code

name of business friend

amount paid

balance

others.

The business friend code is a business friend code in the business friend system 4 which the stock bank system 2 has dealings with, the name of business friend is a business friend's name in the business friend system 4, the amount paid indicates the amount actually paid, and the balance indicates the remaining balance.

The lower row in FIG. 11A shows an example of detailed information of the business friend individual information. The following information is registered corresponding to each other.

business friend code

name of business friend

membership NO

amount paid

balance

scheduled date for transaction completion

YES or NO of transaction completion

delay

others.

The business friend code is a business friend code in the business friend system 4, the name of business friend is a business friend's name in the business friend system 4, the amount paid indicates the amount paid by the member, the balance indicates the balance to be paid by the member, the scheduled date for agreement completion indicates the date on which the balance will be paid off, YES or NO of transaction completion is a column for setting YES or NO of transaction completion, and delay is a column for setting payment delay.

By registering the business friend individual information in the upper and lower rows in FIG. 11A and collectively controlling these information, it becomes possible to collectively control the amount paid and balance for each business friend, and the amount paid, balance and scheduled date for paying off for each member. Also, it becomes possible to inform the amount paid, balance and the like for each business friend and for each member, in response to an inquiry.

FIG. 11B shows an example of debt management DB.

The upper row in FIG. 11B shows the main information of the debt management. The following information is registered corresponding to each other.

membership NO

business friend code

name of business friend

date of purchase

item

total amount to be paid

monthly

number of times to be paid

number of times this month

remaining number of times to be paid

balance

others.

The membership number is a membership NO registered in the stock bank system 2 shown in FIG. 1, the business friend code is a business friend code in the business friend system 4, the name of business friend is a business friend name in the business friend system 4, the date of purchase indicates the date when the member purchased goods, item indicates an item of goods purchased by the member, the total amount to be paid indicates the total amount to be paid for the purchased goods, monthly indicates the amount to be paid in each month, number of times to be paid indicates the number of times to be paid when goods are purchased by installment plan, number of times this month indicates the number of times of payment in this month, remaining number of times to be paid indicates the number of times to be paid in the future, and the balance indicates the balance to be paid.

The lower row in FIG. 11B shows an example of detailed individual information for debt management. The following information is registered corresponding to each other.

membership NO

business friend code

name of business friend

number of times

amount

temporary payment

signature for temporary payment

unchangeable payment

state

form (WEB/mobile)

others.

The membership NO is a membership NO registered in the stock bank system 2, the business friend code is a business friend code in the business friend system 4, the name of business friend is a business friend name in the business friend system 4, the number of times indicates the number of times to be paid, the temporary payment indicates the amount of temporary payment from the banking facility system 3 to the stock bank system 2, and the signature for temporary payment indicates whether an acknowledgement from the business friend system 4 is obtained, and the unchangeable payment indicates the actually debited amount, and the state indicates the state whether the unchangeable payment is OK, or the like. The form is a column for setting whether to inform the information such as billing through the member's WEB or mobile phone.

By registering and controlling the debt information in the upper and lower rows of FIG. 11B, it becomes possible to collectively control the debt information for each business friend and for each member, such as date of purchase, item, total amount to be paid, amount to be paid in each month, number of times to be paid, number of times this month, remaining number of times to be paid, temporary payment and unchangeable payment. Also, it becomes possible to inform the member of the debt information for each business friend and for each member, in response to an inquiry.

As explained above, according to the present invention, it is possible to apply payment on account to the debit by previous arrangement (assignment), or to notify a business friend (credit company) of the preliminary credit information so that temporary payment can be done from the bank account, without waiting for the due date of the installment payment (debt).

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A stock bank system for performing deduction from a user's account comprising:
a transfer unit which transfers a fund from a user's account to the account in a stock bank, with regard to a preliminary payment on account for a debt, and holds the fund as the preliminary payment on account for the debt, when there is an instruction from the user of the preliminary payment on account for the debt from the user's account; and
a notification unit which notifies a business friend of the completion of the preliminary payment on account for the debt, when the transfer is carried out, and deducts the amount of preliminary payment when an acknowledgement of the preliminary payment is obtained from the business friend, or on the due date.

2. A stock bank method for performing deduction from a user's account comprising:
transferring a fund from a user's account to the account in the stock bank, with regard to a preliminary payment on account for a debt, and holding the fund as the preliminary payment on account for the debt, when there is an instruction from the user of the preliminary payment on account for the debt from the user's account; and
notifying a business friend of the completion of the preliminary payment on account for the debt, when the transfer is carried out, and deducting the amount of preliminary payment when an acknowledgement of the preliminary payment is obtained from the business friend, or on the due date.

3. The stock bank method according to claim 2 further comprising deducting a deficit from the user's account, if there is not enough fund at the time of deduction or deduction on the due date.

4. A stock bank method for performing deduction from a user's account comprising:
notifying a user when a bill is received from a business friend and receiving an instruction of transfer;
transferring the amount of the bill or a partial amount of the bill from the user's account to the account in the stock bank, and holding the fund as a preliminary payment on account, when a transfer instruction is received or when it is set such that notification to the user is not necessary; and
notifying the business friend of completion of the preliminary payment on account, when the fund for the preliminary payment is transferred, and deducting the amount of preliminary payment when an acknowledgement of the preliminary payment is obtained from the business friend, or on the due date.

5. The stock bank method according to claim 4 further comprising deducting a deficit from the user's account, if there is not enough fund at the time of deduction or deduction on the due date.

6. A stock bank method for performing deduction from a user's account comprising:
transferring the instructed payment on account under the free title from the user's account to the account in the stock bank, and holding the fund under the free title, when there is an instruction of payment from a user's account under a free title, which does not specify the debit account, from a user; and
reserving the fund under the free title for an amount billed, when a bill is received from a business friend, and holding the fund as a preliminary payment on account, as well as notifying the business friend of completion of the preliminary payment on account, and deducting the amount when an acknowledgement of the preliminary payment is obtained from the business friend, or on the due date.

7. The stock bank method according to claim 6 further comprising deducting a deficit from the user's account, if there is not enough fund at the time of deduction or deduction on the due date.
